(19) United States
(12) Patent Application Publication
(10) Pub. No.: US 2025/0148608 A1
(43) Pub. Date: May 8, 2025

(54) Artificial Intelligence-Driven Automated Frame-to-Frame Panel Reading Experience for Graphic Narratives

(71) Applicant: Global Publishing Interactive, Inc., Troy, OH (US)

(72) Inventors: Robert Hoffer, Miami Beach, FL (US); Christopher Carter, Bloomingdale, IL (US); Shaun Rowan, Troy, OH (US)

(21) Appl. No.: 18/503,862

(22) Filed: Nov. 7, 2023

(51) Int. Cl. G06T 7/12; G06F 3/0483; G06F 40/279; G06T 7/13; G06T 7/194; G06V 10/764; G06V 30/10

(52) U.S. Cl. CPC G06T 7/12; G06F 3/0483; G06F 40/279; G06T 7/13; G06T 7/194; G06V 10/764; G06V 30/10; G06T 2207/20084

(57) ABSTRACT

A system and method are provided for automating the reformatting of graphic narratives (e.g., comic books, manga, etc.) to a digital format. An artificial intelligence (AI) based method identifies panels within the pages, and, based on the relative positions of the panels and the contextual content represented in segmented image and textual elements, the AI-based method predicts a narrative flow among the panels (and within some of the respective panels). Editors either approve or modify the predicted narrative flow. Using the narrative flow, a dynamic path is created to guide the reader's attention through the graphic narrative (e.g., using visual cues and/or an order in which the panels are displayed on a digital device (e.g., an e-reader). The narrative flow can also be used to make the reader's experience more engaging and immersive.

### BACKGROUND

Graphic narratives such as comic books, manga, manhwa, and manhua are increasingly being purchased and consumed in digital formats. These digital formats of graphic narratives can be viewed on dedicated electronic reading devices (i.e., e-readers) or an electronic device (e.g., a smartphone, tablet, laptop, or desktop computer) having software for rendering the digital format of the graphic narrative on a screen of the device.

The digital format provides untapped opportunities to make the user experience more immersive and interactive. Various reformatting of the layout of the graphic narrative can be needed when going from the print format to the digital format. For example, e-readers can have a smaller page size, and therefore, a full-page layout of the original comic book may be difficult to see. Further, the order in which the panels of the comic book are viewed may be in a zig-zag or other nonlinear manner, whereas, the user experience can be improved by one-dimensional scrolling through the comic book (e.g., either left to right or top to bottom). To realize a more enjoyable experience when viewing a graphic narrative in the digital format, a multiple-column comic book, e.g., may be reformatted into a single column. Reformatting the graphic narrative can require first determining which order the panels and visual content is to be viewed/consumed. Currently, determining the panel order is performed by hand, which can be time consuming.

Further, a more enjoyable experience with the digital format of the graphic narrative can be achieved by making the panels more uniform in size and shape, so that they can be scrolled on a digital device. Currently, this too is performed manually.

The formatting can also change depending on the screen size of the device on which the graphic narrative is displayed and depending on user preferences. For example, users with poor eyesight might desire a larger font size for text, which cannot be accommodated on current digital version of graphic narratives.

Additionally, the current presentation of graphic narratives in digital format is largely the same as for print media and fails to take advantage of advances in other areas of technology such as artificial intelligence (AI) and machine learning (ML). For example, advances in generative AI technologies have opened to door to machine-generated images. Further, advances in large language models (LLMs) such as ChatGPT have opened the door to machine-generated text.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example of panels arranged in a page of a graphic narrative, in accordance with some embodiments.

FIG. 2 illustrates a first example of adding panel attributes to the panels, in accordance with some embodiments.

FIG. 3A illustrates an example of a desktop computing device for editing and/or viewing a modified graphic narrative, in accordance with some embodiments.

FIG. 3B illustrates an example of a handheld computing device for viewing the modified graphic narrative, in accordance with some embodiments.

FIG. 4 illustrates an example of a block diagram for a system of generating the modified graphic narrative, in accordance with some embodiments.

FIG. 5 illustrates an example of a flow diagram for a method of generating the modified graphic narrative, in accordance with some embodiments.

FIG. 6 illustrates an example of a block diagram of training a generative adversarial network (GAN), in accordance with some embodiments.

FIG. 7A illustrates an example of a block diagram of a transformer neural, in accordance with some embodiments.

FIG. 7B illustrates an example of a block diagram of an encode block of the transformer neural, in accordance with some embodiments.

FIG. 7C illustrates an example of a block diagram of an decode block of the transformer neural, in accordance with some embodiments.

FIG. 8A illustrates an example of a block diagram of training an AI processor to segment/identify/modify elements in the graphic narrative, in accordance with some embodiments.

FIG. 8B illustrates an example of a block diagram for using a trained AI processor to segment/identify/modify elements in the graphic narrative, in accordance with some embodiments.

FIG. 9 illustrates an example of a block diagram of a computing device, in accordance with some embodiments.

### DESCRIPTION OF EXAMPLES

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In one aspect, a method is provided for determining a narrative flow of a graphic narrative. The method includes determining edges of panels within the graphic narrative; and segmenting elements within the panels. The method further includes applying the segmented elements to a first machine learning (ML) model to predict a narrative flow, the predicted narrative flow comprising an order in which the panels are to be viewed, and assigning, in accordance with the predicted narrative flow, index values to the respective panels, the index values representing positions in an ordered list that corresponds to the predicted narrative flow.

In another aspect, the method may also include that segmenting the elements within the panels further comprising applying a second ML model to identify objects depicted in image elements of the segmented elements and applying a third ML model to identify text elements of the segmented elements; and applying the segmented elements to the first ML model to predict the narrative flow further comprises analyzing relations among the text elements a same page to determine first scores representing likelihoods for an order in which the text elements are viewed, analyzing relations among the text elements a same page to determine second scores representing likelihoods for an order in which the image elements are viewed, and combining the first scores and the second scored to predict order in which the panels are to be viewed.

In another aspect, the method may also include that applying the segmented elements to the first ML model to predict the narrative flow further comprises predicting a flow of action within one or more of the panels.

In another aspect, the method may also include that the one or more of the panels have larger area than an average area of the panels, and the method further comprises displaying the graphic narrative in a digital format by showing multiple views for each panel of the one or more of the panels, such that a first view of the multiple views shows a part of the each panel corresponding to a first occurrence in the flow of the action and a second view of the multiple views shows a part of the each panel corresponding to a second occurrence, wherein the first occurrence proceeds the second occurrence in the flow of the action.

In another aspect, the method may also include that displaying the graphic narrative in the digital format further comprises transitioning from the first part of the each panel to the second part of the each panel by zooming, panning, changing a focus, highlighting, or fading from the first part of the each panel to the second part of the each panel.

In another aspect, the method may also include determining scores representing uncertainties for the index values of the respective panels within the ordered list; flagging panels for which the scores of the flagged panels exceed a predefined threshold; sending, to a user, the panels associated with the corresponding index values and indicia of which of the panels have been flagged; and modifying the predicted narrative flow based on the user inputs indicating corrections to the predicted narrative flow.

In another aspect, the method may also include ingesting the graphic narrative; slicing the graphic narrative into respective pages and determining an order of the pages; determining that panels on a page earlier in the order of the pages occur earlier in the predicted narrative flow than panels on a page that is later in the order of the pages; and displaying, on a display of a device, the panels according to the predicted order in which the panels are to be viewed.

In another aspect, the method may also include displaying, on a display of a device, the panels according to the predicted order in which the panels are to be viewed, and rendering the panels in accordance with a screen size of the display of the device, wherein the device is an electronic reading device, a tablet or a smartphone on which is running electronic reading application; a website accessed via a web browser; or printing a copy of an electronic version of the graphic narrative.

In another aspect, the method may also include modifying the panels to increase a uniformity of a size and/or shape of the panels, such that the modified panels are compatible with being displayed as an electronic version of the graphic narrative.

In another aspect, the method may also include displaying, on a display of a device, the panels with a visual indicator directing a reader according to the predicted narrative flow.

In another aspect, the method may also include receiving reader inputs that control an advancement of the graphic narrative along the predicted narrative flow.

In another aspect, the method may also include that segmenting elements within the panels further comprises: applying a second ML model to a panel of the panels, the first ML model determining, within the panel, bounded regions corresponding background, foreground, text bubbles, objects, and/or characters, and identifying the bounded regions as the segmented elements.

In another aspect, the method may also include that the first ML model is a semantic segmentation method that is selected from the group consisting of a Fully Convolutional Network (FCN) method, a U-Net method, a SegNet method, a Pyramid Scene Parsing Network (PSPNet) method, a DeepLab method, a Mask R-CNN, an Object Detection and Segmentation method, a fast R-CNN method, a faster R-CNN method, a You Only Look Once (YOLO) method, a fast R-CNN method, a PASCAL VOC method, a COCO method, a ILSVRC method, a Single Shot Detection (SSD) method, a Single Shot MultiBox Detector method, and a Vision Transformer (ViT) method.

In another aspect, the method may also include that applying the segmented elements to the first ML model further includes: applying, to the respective image elements, an image classifier to identify a type of an object illustrated within the respective image element; and applying, to respective of the text elements, a character recognition method to determine text of the respective text element and applying the text to a language model to determine one or more referents of the text.

In another aspect, the method may also include that the image classifier is selected from the group consisting of a K-means method, an Iterative Self-Organizing Data Analysis Technique (ISODATA) method, a YOLO method. A ResNet method, a ViT method, a Contrastive Language-Image Pre-Training (CLIP) method, a convolutional neural network (CNN) method, a MobileNet method, and an EfficientNet method; and the language model is selected from the group consisting of a transformer method, a Generative pre-trained transformers (GPT), a Bidirectional Encoder Representations from Transformers (BERT) method, and a T5 method.

In one aspect, a computing apparatus includes a processor. The computing apparatus also includes a memory storing instructions that, when executed by the processor, configure the apparatus to perform the respective steps of any one of the aspects of the above-recited methods.

In one aspect, a computing apparatus includes a processor. The computing apparatus also includes a memory storing instructions that, when executed by the processor, configure the apparatus to determine edges of panels within respective sheets of the graphic narrative; segment elements within the panels; apply the segmented elements to a first machine learning (ML) model to predict a narrative flow, the predicted narrative flow comprising an order in which the panels are to be viewed; and assign, in accordance with the predicted narrative flow, index values to the respective panels, the index values representing positions in an ordered list that corresponds to the predicted narrative flow.

In another aspect, the computing apparatus may also include that, when executed by the processor, the instructions stored in the memory further configure the apparatus to segment the elements within the panels by applying a second ML model to identify objects depicted in image elements of the segmented elements and applying a third ML model to identify text elements of the segmented elements; and apply the segmented elements to the first ML model to predict the narrative flow by analyzing relations among the text elements a same page to determine first scores representing likelihoods for an order in which the text elements are viewed, analyzing relations among the text elements a same page to determine second scores representing likelihoods for an order in which the image elements are viewed, and combining the first scores and the second scored to predict order in which the panels are to be viewed.

In another aspect, the computing apparatus may also include that, when executed by the processor, the instructions stored in the memory further configure the apparatus to determine scores representing uncertainties for the index values of the respective panels within the ordered list; flag panels for which the scores of the flagged panels exceed a predefined threshold; send, to a user, the panels associated with the corresponding index values and indicia of which of the panels have been flagged, and modify the predicted narrative flow based on the user inputs indicating corrections to the predicted narrative flow.

In another aspect, the computing apparatus may also include that, when executed by the processor, the instructions stored in the memory further configure the apparatus to ingest the graphic narrative; slice the graphic narrative into respective pages and determine the order of the pages; determine that panels on a page earlier in the order of the pages occur earlier in the predicted narrative flow than panels on a page that is later in the order of the pages; and display, on a display of a device, the panels according to the predicted order in which the panels are to be viewed.

In another aspect, the computing apparatus may also include that, when executed by the processor, the instructions stored in the memory further configure the apparatus to display, on a display of a device, the panels according to the predicted order in which the panels are to be viewed, and rendering the panels in accordance with a screen size of the display of the device, wherein the device is an electronic reading device, a tablet or a smartphone on which is running an electronic reading application; a website accessed via a web browser; or printing a copy of an electronic version of the graphic narrative.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art to more efficiently convert print versions of graphic narratives to digital versions of graphic narratives, for example by using machine learning (ML) and artificial intelligence (AI) tools to substantially automate the determination of the narrative flow, and converting a print version of the graphic narrative to a digital version that can be viewed, e.g., in an e-reader (e.g., making it easy to scroll through in the digital format. Further, the disclosed technology addresses the need in the art to take advantage of advancements in technologies to create a more immersive user experience when interacting with a digital version of a graphic narrative.

The methods and systems disclosed herein provide improvements in the area of digital and printed versions of graphic narratives (e.g., comic books). For example, the methods and systems disclosed herein allow the images and/or text in the graphic narrative to be modified to make the panels more uniform in size and shape, such that they are compatible to be scrolled through on an e-reader device or application. For example, when the digital version is scrolled horizontally, the panels can be modified to have substantially the same vertical dimension (height), which is compatible with the height of the panel viewing area on the screen of the e-reader. Similarly, when the digital version is scrolled vertically, the panels can be modified to have substantially the same horizontal dimension (width), which is compatible with the width of the panel viewing area on the screen of the e-reader.

According to certain non-limiting examples, the images can include visual cues that draw the reader's attention to the portion of the panel where the action is according to the narrative flow. For example, the center pages in a comic book can include a two-page panel that includes different regions in the panel that represent different occurrences/events in the narrative flow. These can be presented in an e-reader by highlighting or zooming/panning to those different regions in accordance with the narrative flow.

According to certain non-limiting examples, the panels in the print version of the graphic narrative can have irregular shapes (e.g., a trapezoid or part of a rectangular panel can be obscured). A generative AI tool can be used to draw a missing portion of a panel to convert the irregularly shaped panel to a rectangularly shaped panel.

According to certain non-limiting examples, the methods and systems disclosed herein enable automating the reading of comic book panels. For example, the methods and systems disclosed herein can use AI models to analyze the content of each panel and the relationships between panels. Further, the reader's attention can be guided from panel to panel, and the reader's attention can be guided within each panel using visual cues (e.g., superimposing an element or shape that guides the reader's attention, highlighting, changing the contrast, bringing various parts of the foreground in/out of focus, and panning or zooming to center the panel on the location where the action is occurring), thereby creating a dynamic, engaging, and immersive reading experience.

According to certain non-limiting examples, the methods and systems disclosed herein can leverage AI models (e.g., machine learning models, deep learning models, and natural language processing models) to perform tasks such as: (i) panel detection and sequencing; (ii) content analysis; (iii) narrative flow creation; and (iv) create an interactive experience. For panel detection and sequencing, e.g., an AI system can be used to identify individual panels on a page and determine their intended reading order based on comic book conventions (e.g., left-to-right, top-to-bottom for English-language comics or right-to-left, top-to-bottom for Japanese-language manga), artistic cues, and textual cues. For content analysis, an AI system can be used to analyze visual elements within and among the respective panels (e.g., characters, objects, locations, action sequences) and textual elements (e.g., dialogue, captions, sound effects) to understand the content of the panel. For narrative flow creation, The AI system then uses the results of the content analysis to create a dynamic path that guides the reader's attention through each panel and from one panel to the next. This path can include elements such as zoom, pan, and transition effects. Regarding the creation of an interactive experience, the system provides an interactive reading experience where the reader can manually control the path, or let the AI guide the reading process, thereby enhancing the narrative flow experienced by the reader.

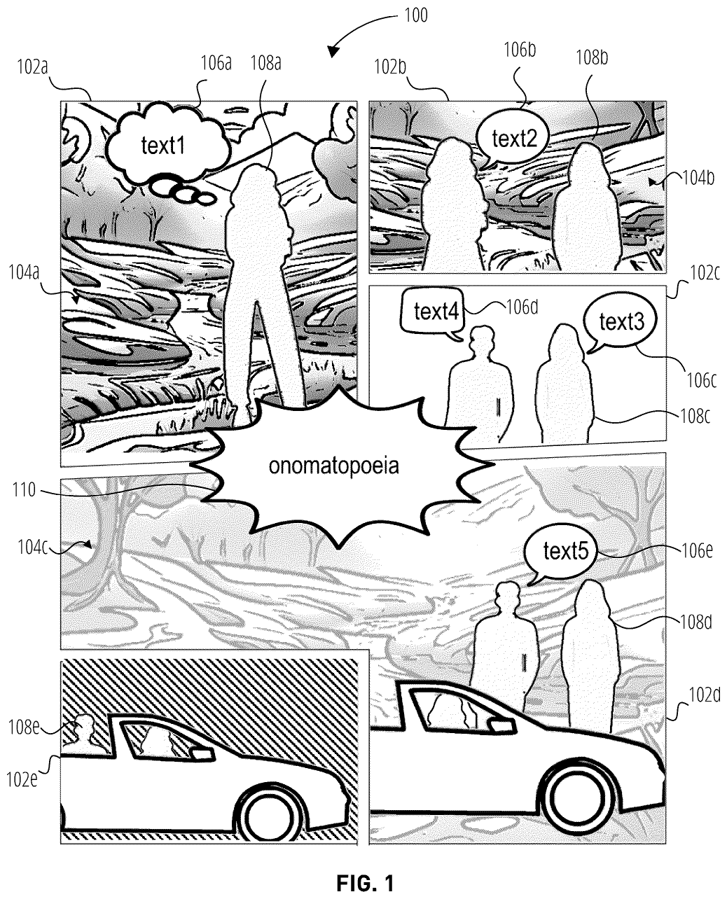

FIG. 1 illustrates a page 100 from a graphic narrative (e.g., a comic book, manga, manhwa, manhua, anime, animated moving picture, etc.). The page 100 includes five panels (i.e., a first panel 102a, a second panel 102b, a third panel 102c, a fourth panel 102d, and a fifth panel 102e). The respective panels can be segmented into parts, including, e.g., a background, a foreground, and bubbles. These parts can be further subdivided into elements, such as characters, objects, text, signs, etc. For example, the first panel 102a includes the background 104a, the foreground 108a, and the bubble 106a. Similarly, the second panel 102b includes bubble 106b, background 104b, and foreground 108b, and the third panel 102c includes bubble 106c, bubble 106d, and foreground 108c, bubble 106c, and bubble 106b. The fourth panel 102d includes background 104c, bubble 106e, and foreground 108d, The fifth panel 102e includes the foreground 108e and background 104c. In between the first panel 102a, third panel 102c, and fourth panel 102d is an exclamation bubble with an onomatopoeia 110.

Page 100 exhibits several features that can be found in comic books. First, in English-language comic books, the convention is to read the panels left-to-right and top-to-bottom. Generally, an AI model for determining the narrative flow, will learn this pattern and apply it. But the panels can be of different sizes and shapes, and, when the only context clue is the relative location of the panels on the page, there can be some ambiguity regarding which panel comes before which. The images and text in the panels will often be sufficient to resolve this ambiguity. For example, an AI model can statistically learn various casual context clues. For example, in a superhero fight scene, a windup for a punch or kick proceeds certain after-effects from the punch or kick, and characters/vehicles typically move forward through an environment. Additionally, certain large language models can predict which text is likely to follow which other text. Thus a combination of the relative locations of the panels, the image elements represented within the panels, and the text within the panels provide sufficient context clues for an AI model (or combination of AI models) to determine which order panels should be presented to adhere to a narrative flow of the graphic narrative.

Further, as discussed more below, various AI models can be used to determine the areas and bounds of the panels. Other AI models can segment the images into image and text elements and then analyze these segments to ascertain/identify the objects depicted in the image elements and the referents/meaning of the text elements. Additional AI models can compare the identified objects and referents between respective panels (or within a given panel) to determine the narrative flow among the panels (or within the given panel).

According to certain non-limiting examples, the panels can be modified to be compatible with viewing in a digital format. For example, the font size of the text can be modified for visually impaired readers. Further, the size of the bubbles can be modified consistent with the change in the font size. This can entail using a generative AI tool to redraw part of the image elements. Additionally or Alternatively, the text in the bubbles can be modified using a large language model (LLM), For example, to abbreviate the text without substantively changing its meaning. Thus, the modifications to text or dialog can be made to be consistent with the storyline, such that the modifications do not disrupt of flow of the storyline. Further, the font and style of the text can be adapted to be consistent with the style of graphic narrative. This can be achieved by using a generative artificial intelligence (AI) method to learn a style of the author/artist of the graphic narrative, and generating the modifications in the same style as the author/artist.

Additionally, the images within the graphic narrative can be modified as long as such modifications do not disrupt the storyline or narrative flow. For example, the first panel 102a, third panel 102c, and fourth panel 102d each have irregular (non-rectangular) shapes. In each of these cases, the panels can be extended to a rectangular shape using a generative AI tool to draw additional background and foreground and thereby make these consistent with how they will be displayed in an e-reader, for example. That is, modified images can be achieved by using a generative AI method that learns a style of the author/artist of the graphic narrative, and generates modified images in the same style as the author/artist. Further, the modified images can be presented to the author/artist who then edits the modified images, if further editing is beneficial.

Additionally or alternatively, text and images can be modified in the background as well as in the foreground of the graphic narrative. Thus, modifications to graphic narrative can include modifying the formatting of panels to adapt them from a comic book format (or other graphic narrative format) to a format that is compatible with being displayed in an electronic reader (e-reader), a reader application, or in a webpage. For example, on page 100, the size and shape of the panels are not uniform (e.g., some panels are not even rectangular). Further, on page 100, the trajectory of the reader's eye when following the narrative is not a straight line. The panels can be reformatted so that they can be more uniform in shape and so that they be scrolled either vertically or horizontally in an e-reader, for example. To make the panels more uniform in shape and size, a generative AI method can be used to fill in missing portions of the background and/or foreground.

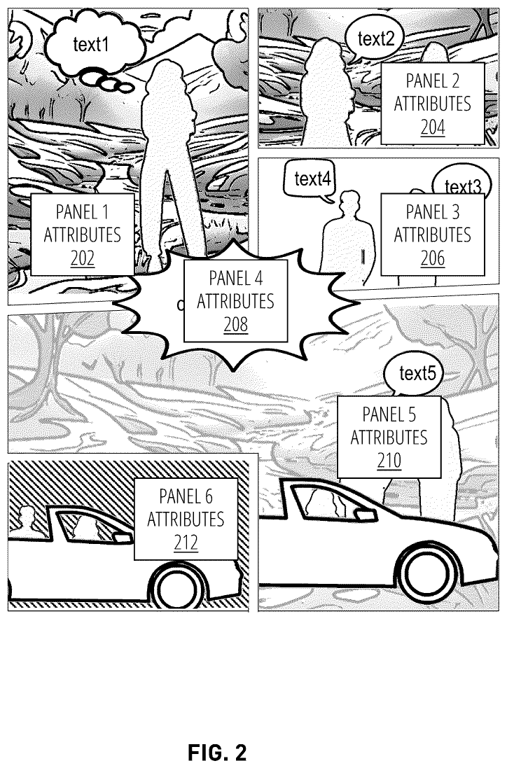

FIG. 2 illustrates an example of labeling an order of the panels according to a predicted narrative flow. Here, the first panel 102a has been labeled with panel 1 attributes 202. This can include an index value that represents the position of this panel in an ordered list of the narrative flow. Further, the panel attributes can include a score representing the uncertainty or confidence that the position of this panel in the ordered list is correct. Using an AI model to predict the narrative flow can save significant time for authors/editors of the graphic narrative. But the AI model may occasionally be wrong or may not have sufficient information to make a confident prediction. Thus, the authors/editors can review the automated results from the AI model for the predicted narrative flow and make changes where the AI model erred. Even with the time required for this review, the authors/editors can still save a significant amount of time when very few of the predictions are wrong (e.g., less the 5% or less than 1% of the predictions of the narrative flow are incorrect). The review time can be reduced by flagging those panels for which there is a high uncertainty (low confidence) for the predicted index value. Which panels to flag can be determined by comparing uncertainty scores (or confidence scores) to a predefined threshold. Then, those panels are flagged for which the uncertainty scores fall within a predefined range (e.g., the uncertainty scores exceed a predefined threshold or the confidence scores fall below a predefined threshold). The authors/editors are thus alerted to pay particular attention to the flagged panels.

Changes made by the authors/editors can be used as negative examples for reinforcement learning by the AI model. Additionally, the authors/editors indicate that the index value was correct when they do not make a change to a flagged panel. These true positive results can also be used as a positive example for reinforcement learning.

The other panels in FIG. 2 are also labeled with panel attributes. The second panel 102b is labeled with the panel 2 attributes 204, and the third panel 102c is labeled with the panel 3 attributes 206. The bubble showing onomatopoeia 110 is labeled with the panel 3 attributes 206, and the fourth panel 102d is labeled with the panel 4 attributes 208. The fifth panel 102e is labeled with the panel 6 attributes 212.

In the narrative flow, the onomatopoeia 110 can be displayed superimposed over the third panel 102c before transitioning to the fourth panel 102d. The panel 4 attributes 208 can include various fields, one of which indicates that a panel is an onomatopoeia so that it can be transitioned and displayed in a particular way that evokes the feeling of the onomatopoeia. For example, the onomatopoeia “pow” can transition by exploding out of the center of the action. Further, the onomatopoeia “zoom” can fly in from a side to a location of the action in the panel.

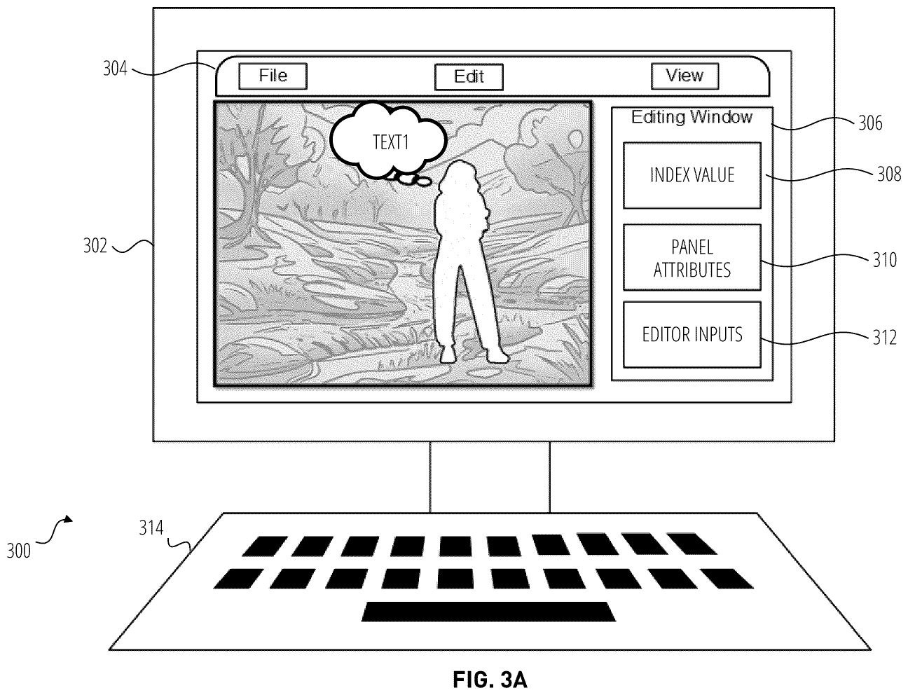

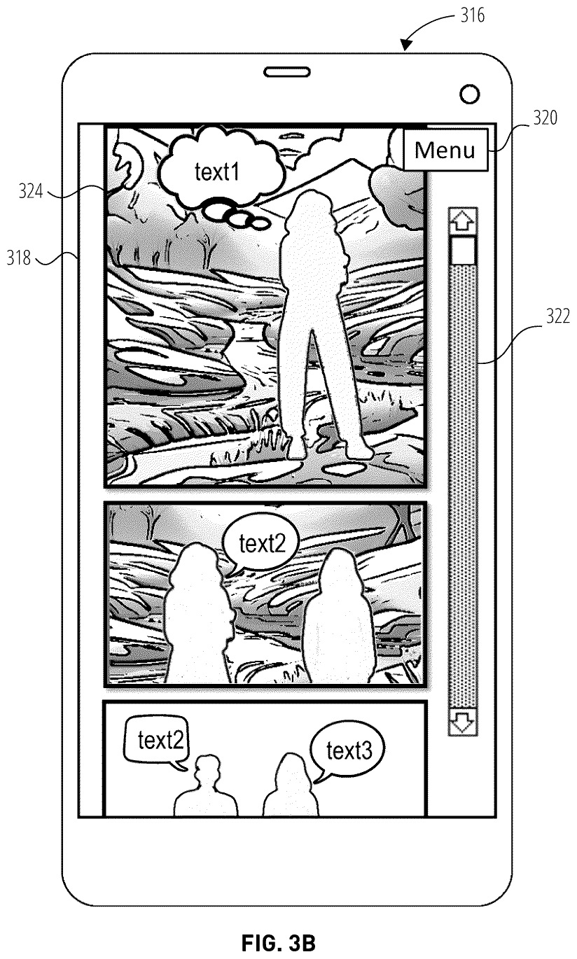

FIG. 3A illustrates a computing system 300 for modifying the graphic narrative and providing a desired format for displaying the modified graphic narrative on a screen of a user device. The computing system 300 includes a display 302 (e.g., a computer monitor) and an input device 314 (e.g., a mouse and/or keyboard). The display 302 displays a window that includes a current version of a modified panel, a menu ribbon 304, and an editing window 306. The current version of a modified pane can include AI generated modifications to the text and/or the image. The menu ribbon 304 can provide options for changing a view, changing editing tools, saving a file, etc.

The editing window 306 can include an area for the index value 308, panel attributes 310, and for editor inputs 312. The index value 308 can show the predicted index value. The panel attributes 310 can allow the author or editor to view attributes that were predicted for the shown panel. The editor inputs 312 can allow an author or editor to make changes to the narrative flow, e.g., by changing the index value or by changing the transitions between panels.

FIG. 3B illustrates a mobile device 316 for displaying the modified graphic narrative within a display 318. According to certain non-limiting examples, the mobile device 316 includes a menu 320 that allows a reader to change the display settings or customize the viewing experience using various drop-down menus and/or options menus. The mobile device 316 can include a scroll bar 322 or other tools to enter user inputs to manually control the path, or let the AI guide the reading process, enhancing the narrative flow.

The mobile device 316 can be an e-reader that allows the reader to scroll through the panels vertically or horizontally. The mobile device 316 can be a user device such as a smartphone, a tablet, or a computer on which an application or software is installed that provides a multi-modal viewing experience by allowing the reader to view the panels arranged vertically, horizontally, or as a double paged spread. Additionally or Alternatively, a reader can view the graphic narrative using a web browser displayed on a monitor or display of a computer. The web browser can be used to access a website or content provider that displays the modified graphic narrative within the web browser or an application of the content provider.

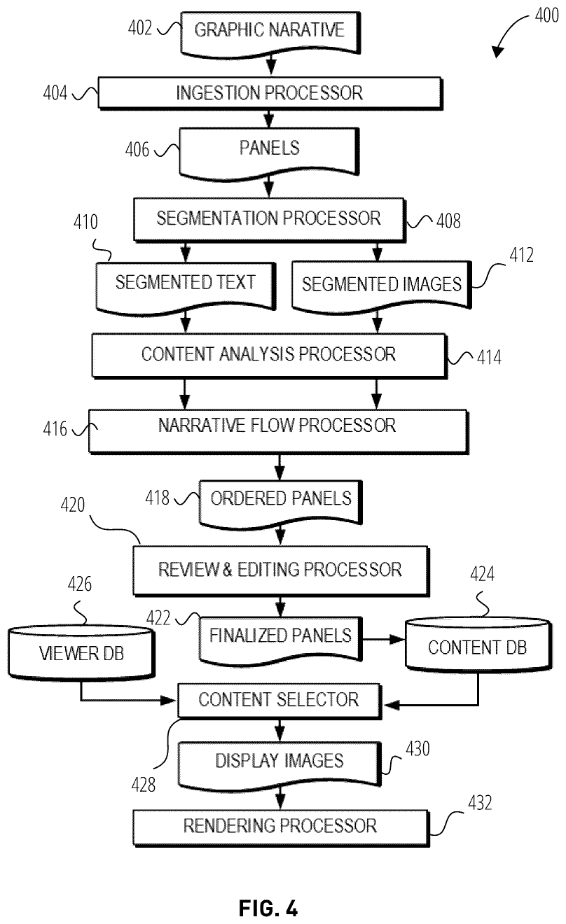

FIG. 4 illustrates a system 400 for generating and displaying the modified graphic narrative.

The graphic narrative 402 is received by an ingestion processor 404, which ingests a digital version of the graphic narrative 402. For example, the digital version can be generated by scanning physical pages of the graphic narrative. The digital version can be a Portable Document Format (PDF) file or another file extension type. The ingestion processor 404 identifies respective areas and boundaries for each of the panels. For example, the ingestion processor 404 can identify the edges of the panels and where the panels extend beyond nominal boundaries.

The segmentation processor 408 receives the panels 406 and generates therefrom segmented elements, including segmented text 410 and segmented images 412. As discussed above, the segmented text 410 can include text in various types of bubbles, as well as other text appearing in the panels 406, such as onomatopoeia, text blocks, and narration.

The text can be in any of multiple different formats, including text in speech bubbles, thought bubbles, narrative boxes, exposition, onomatopoeia (e.g., “wow,” “pow,” and “zip”), text appearing in the background (e.g., on signs or on objects). Further, the text can be in various sizes and fonts or can even be hand-lettered text.

The panels can be segmented using various methods and techniques, such as semantic segmentation models, which include Fully Convolutional Network (FCN) methods, U-Net methods, SegNet methods, a Pyramid Scene Parsing Network (PSPNet) methods, and DeepLab methods. The segmentation processor 408 can also segment the panels 406 using image segmentation models, such as Mask R-CNN, GrabCut, and OpenCV. The segmentation processor 408 can also segment the panels 406 using Object Detection and Image Segmentation methods, such as fast R-CNN methods, faster R-CNN methods, You Only Look Once (YOLO) methods, PASCAL VOC methods, COCO methods, and ILSVRC methods. The segmentation processor 408 can also segment the panels 406 using Single Shot Detection (SSD) models, such as Single Shot MultiBox Detector methods. The segmentation processor 408 can also segment the panels 406 using detection transformer (DETR) models such as Vision Transformer (ViT) methods.

Many of the above methods identify the objects within the segmented elements, but, for other segmentation methods, a separate step is used to identify the object depicted in the segmented elements. This identification step can be performed using a classifier method or a prediction method. For example, identifying segmented images 412 can be performed using an image classifier, such as K-means methods or Iterative Self-Organizing Data Analysis Technique (ISODATA) methods. The following methods can also be trained to provide object identification capabilities for segmented images: YOLO methods, ResNet methods, ViT methods, a Contrastive Language-Image Pre-Training (CLIP) methods, convolutional neural network (CNN) methods, MobileNet methods, and EfficientNet methods.

For segmented text 410, a two-step process can be used in which optical character recognition is used, e.g., to map a segment with text to an order set of alphanumeric characters (e.g., an ASCII character string of the text), and then a language model is applied to determine the referent or the type referent that is referred to by the text. For example, a natural language processing (NLP) model or large language model (LLM) can be used such as a transformer method, a Generative pre-trained transformers (GPT) method, a Bidirectional Encoder Representations from Transformers (BERT) method, or a T5 method.

The narrative processor 416 determines an order in which the storyline flows from one panel to another (and flows within a given panel), resulting in an ordered set of panels 418, including definitions or boundaries for what constitutes the extent of each of the panels.

According to certain non-limiting examples, the narrative processor 416 refers to the locations of the individual panels on a page and predicts their intended reading order based on comic book conventions (e.g., left-to-right, top-to-bottom for English-language comics), artistic cues, and textual cues. Further, the narrative processor 416 can analyze visual elements (e.g., characters, objects, locations, action sequences) and textual elements (e.g., dialogue, captions, sound effects) to understand the content of the panel. The narrative processor 416 can uses the results of the content analysis to create a dynamic path that guides the reader's attention through each panel and from one panel to the next. This path can include elements such as zoom, pan, and transition effects.

For modified image elements, the narrative processor 416 can use one or more generative AI methods to create, based on the original image, modified panels. The generative AI methods can use, e.g., generative adversarial network (GAN) methods, Variational autoencoders (VAEs) methods, Deep Dream methods, Neural Style Transfer methods, and/or Stable Diffusion Generator methods. These can be trained using the author's/illustrator's work product that is in the same style as the graphic narrative to generate modified images that are consistent with and seamlessly integrate with the graphic narrative. The resultant images can be presented to an author/editor, who then reviews and/or edits the AI-generated images.

Then, the modified image elements and modified text elements are integrated into the corresponding panels to provide the ordered panels 418.

The ordered panels 418 can then be processed by a review and editing processor 420 to generate the finalized panels 422, which are then stored in a content database 424. The finalized panels 422 can include indicia that signal to a reader which of the panels are interactive to provide a more immersive reader experience. For example, the interactive panels can have a unique border or other feature that identifies them as being interactive. Interacting with the designated panels can be performed, e.g., by clicking/selecting the panel.

Several versions of the modified graphic narrative can be stored in the content database 424. For example, a first version might use the original font size for text, and a second version might have a larger font size for vision-impaired readers. Additionally or alternatively, the first version might have more whimsical transitions between panels and more immersive features, whereas the second version has panels that are only scrolled in one dimension. When the viewer database 426 indicates that the reader of the graphic narrative has a particular preference (e.g., larger font size or more immersive reading experience), then the version corresponding to the reader's preferences can be selected and rendered by the renderer 432 on the reader's device. That is, the content selector 428 can select from the content database 424 a version of the graphic narrative that is consistent with the reader's preferences, as represented in the viewer database 426.

The renderer 432 takes the display images 430 and determines how to render them for a particular device and in a particular user interface (UI) or user experience (UX) that is being used for viewing the display images 430 of the graphic narrative

The system 400 can be distributed across multiple computing platforms and devices. For example, units 404, 408, 414, 416, and 420 can be located on a computing system 300 of the author/editor or in a cloud computing environment. Additionally, units 404, 408, 414, and 416 can be located on a computing system 300 of the publisher, and unit 420 can be located on a computing system 300 of the author/illustrator. Further, units 428 and 432 can be located on a reader's mobile device 316 or in a cloud computing environment.

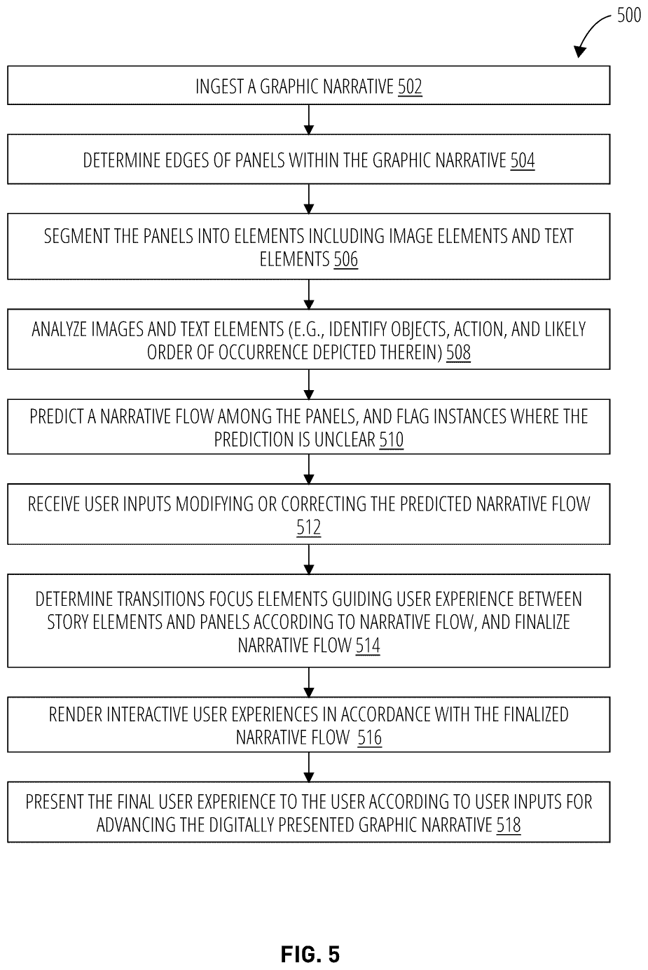

FIG. 5 illustrates an example method 500 for converting a graphic narrative to a digital format, predicting the narrative flow, and making the reader experience more immersive. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

According to certain non-limiting examples, step 502 of the method includes ingesting a graphic narrative. Step 502 can be performed by the ingestion processor 404 in FIG. 4, for example.

According to certain non-limiting examples, step 504 of the method includes determining the edges of panels within the graphic narrative. Step 504 can be performed by the ingestion processor 404 in FIG. 4, for example.

According to certain non-limiting examples, step 506 of the method includes segmenting the panels into elements including image elements and text elements. Step 506 can be performed by the segmentation processor 408 in FIG. 4, for example. The segmentation can be performed, e.g., using semantic segmentation models (e.g., FCN, U-Net, SegNet, PSPNet, DeepLab, etc.) that perform semantic segmentation using an Encoder-Decoder structure or Multi-Scale representation structure, thereby generating distinct segments that correspond to respective elements within each of the panels. Other segmentation models, which are discussed with reference to FIG. 4, can also be used to perform step 506.

The segmented elements can include background, foreground, text bubbles, text blocks, and onomatopoeia, and the background and foreground can be further sub-divided into individual characters, objects, and buildings.

According to some examples, step 508 of method 500 includes analyzing images and text elements (e.g., identify objects, action, and likely order of occurrence depicted therein).

According to certain non-limiting examples, step 510 of the method includes predicting a narrative flow among the panels. Step 510 can be performed by the narrative processor 416 in FIG. 4, for example.

According to certain non-limiting examples, step 510 of the method includes predicting a narrative flow among the panels, and flagging instances where the prediction is unclear. Step 510 can include identifying objects depicted in the image elements and referents referred to in the text elements. Step 510 can be performed by the segmentation processor 408 in FIG. 4, for example. Object identification and pattern recognition models, which are discussed with reference to FIG. 4, can be used to perform step 510.

According to certain non-limiting examples, step 510 can include applying the segmented elements to a first machine learning (ML) model to predict a narrative flow, the predicted narrative flow comprising an order in which the panels are to be viewed. step 510 can further include assigning, in accordance with the predicted narrative flow, index values to the respective panels, the index values representing positions in an ordered list that corresponds to the predicted narrative flow.

According to certain non-limiting examples, applying the segmented elements to the first ML model to predict the narrative flow can include: analyzing relations among the text elements the same page to determine first scores representing likelihoods for an order in which the text elements are viewed, analyzing the relations among the text elements a same page to determine second scores representing likelihoods for an order in which the image elements are viewed, and combining the first scores and the second scored to predict order in which the panels are to be viewed.

Step 510 can also include predicting a flow of action within one or more of the panel. For example, some panels are larger than others (e.g., they have a larger area than the average area of the panels). For larger panels, the digital format can extract and show multiple digital panels from a single print panel. That is, multiple digital views can be generated from the larger panels, such that a first view of the multiple views shows a part of the larger panel corresponding to earlier events in the narrative flow and a second view of the multiple views shows a part of the larger panel corresponding to later events in the narrative flow.

According to certain non-limiting examples, step 510 includes determining scores representing uncertainties for predicted index values of the respective panels within an ordered list, and then flagging panels for which the scores of the flagged panels exceed a predefined threshold. Indicia of the flagged panels is sent to an editor who reviews the flagged panels to double check that the flagged panels are correctly labeled with an index value that ensures proper narrative flow. If a panel is incorrectly labeled, then user inputs are received at step 512 to correct the error, and the predicted narrative flow is modified based on the editor's input to correct the narrative flow.

According to some examples, the method includes receiving user inputs to modify or correct the predicted narrative flow at step 512. Step 512 can be performed by the review and editing processor 420 in FIG. 4.

According to certain non-limiting examples, step 514 of the method includes determining transitions focus elements guiding user experience between story elements and panels according to narrative flow and finalizing narrative flow. Step 514 can further include modifying some of the elements to be compatible with being displayed in an e-reader. Step 514 can be performed by the narrative processor 416 and the review and editing processor 420 in FIG. 4 and use one or more of the generative AI methods disclosed in reference to FIG. 4. Step 514 can include modifying panels to have a more uniform size and shape. For image elements, a GAN method can be used to generate a modified image element. For text elements, an LLM can be used to transform the original text, and a GAN can be used to render that text in the style/font of the original text element.

According to some examples, the method includes rendering interactive user experiences in accordance with the finalized narrative flow at step 516. Step 516 can be performed by the review and editing processor 420 in FIG. 4, for example.

According to certain non-limiting examples, step 516 displaying the graphic narrative in the digital using transitions between panels. Examples of transition between panels can include, e.g., zooming or panning from one region of a large panel to another region of a larger panel, changing which part of the panel is in focus, changing a portion of the panel that is highlighted, or fading from one panel to another panel.

According to some examples, the method includes presenting the final user experience to the user according to user inputs for advancing the digitally presented graphic narrative at step 518.

According to certain non-limiting examples, step 518 of the method includes displaying a digital version of the graphic narrative on an electronic reader, an application, or within a web browser. Step 518 can be performed by renderer 432 in FIG. 4.

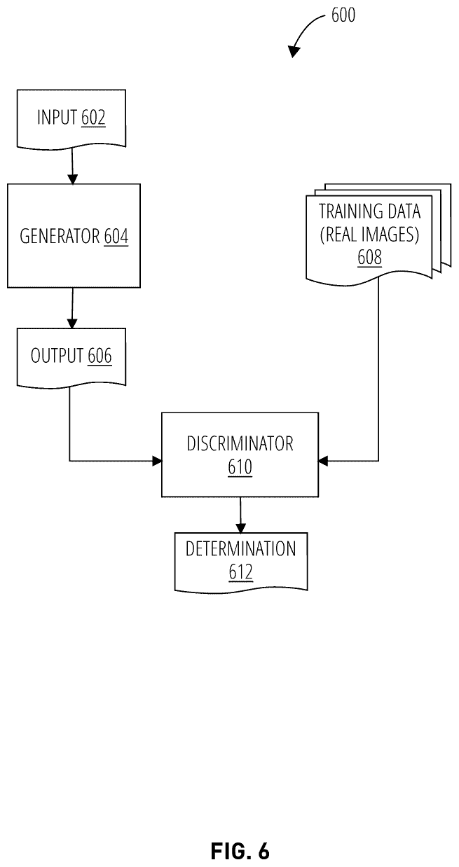

FIG. 6 illustrates a GAN architecture 600. The GAN architecture 600 has two parts: the generator 604 and the discriminator 610. The generator 604 learns to generate plausible images. The discriminator 610 learns to distinguish the plausible images of the generator 604 from real images. The discriminator 610 receives two images (i.e., the output 606 from the generator 604 and a real image from the training data 608), and analyzes the two received images to make a determination 612 which is the real image. The generator 604 fools the discriminator 610 when the determination 612 is incorrect regarding which of the images received by the discriminator 610 was real.

Both the generator and the discriminator are neural networks with weights between nodes in respective layers, and these weights are optimized by training against the training data 608, e.g., using backpropagation. The instances when the generator 604 successfully fools the discriminator 610 become negative training examples for the discriminator 610, and the weights of the discriminator 610 are updated using backpropagation. Similarly, the instances when the generator 604 is unsuccessfully in fooling the discriminator 610 become negative training examples for the generator 604, and the weights of the generator 604 are updated using backpropagation.

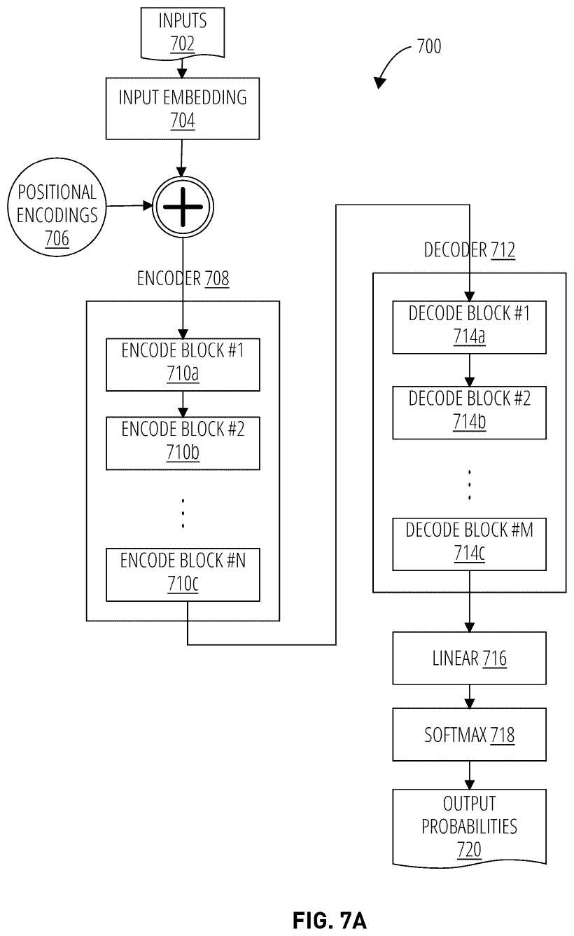

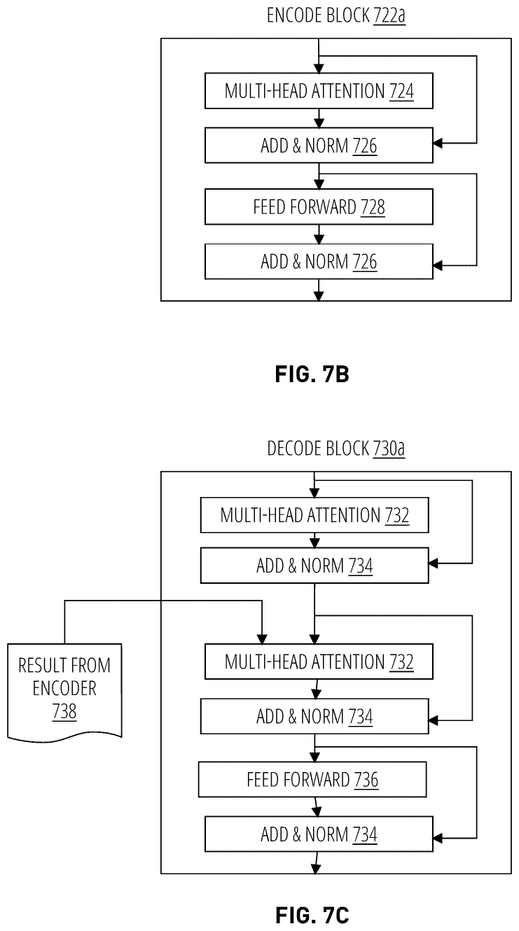

A transformer architecture 700 could be used to interpret and generate text for the modified panels. Examples of transformers include a Bidirectional Encoder Representations from Transformer (BERT) and a Generative Pre-trained Transformer (GPT). The transformer architecture 700, which is illustrated in FIG. 7A through FIG. 7C, includes inputs 702, an input embedding block 704, positional encodings 706, an encoder 708 (e.g., encode blocks 710a, 710b, and 710c), a decoder 712 (e.g., decode blocks 514a, 514b, and 714c), a linear block 716, a softmax block 718, and output probabilities 720.

The input embedding block 704 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 704 can be learned embeddings to convert the input tokens and output tokens to vectors of dimension have the same dimension as the positional encodings, for example.

The positional encodings 706 provide information about the relative or absolute position of the tokens in the sequence. According to certain non-limiting examples, the positional encodings 706 can be provided by adding positional encodings to the input embeddings at the inputs to the encoder 708 and decoder 712. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that so doing allows the model to extrapolate to sequence lengths longer than the ones encountered during training.

The encoder 708 uses stacked self-attention and point-wise, fully connected layers. The encoder 708 can be a stack of N identical layers (e.g., N=6), and each layer is an encode block 710, as illustrated by encode block 710a shown in FIG. 7B. Each encode block 710 has two sub-layers: (i) a first sub-layer has a multi-head attention encode block 722a and (ii) a second sub-layer has a feed forward add & norm block 726, which can be a position-wise fully connected feed-forward network. The feed forward add & norm block 726 can use a rectified linear unit (ReLU).

The encoder 708 uses a residual connection around each of the two sub-layers, followed by an add & norm multi-head attention block 724, which performs normalization (e.g., the output of each sub-layer is LayerNorm (x+Sublayer (x)), i.e., the product of a layer normalization “LayerNorm” time the sum of the input “x” and output “Sublayer (x)” pf the sublayer LayerNorm (x+Sublayer (x)), where Sublayer (x) is the function implemented by the sub-layer). To facilitate these residual connections, all sub-layers in the model, as well as the embedding layers, produce output data having a same dimension.

Similar to the encoder 708, the decoder 712 uses stacked self-attention and point-wise, fully connected layers. The decoder 712 can also be a stack of M identical layers (e.g., M=6), and each layer is a decode block 714, as illustrated by encode decode block 714a shown in FIG. 7C. In addition to the two sub-layers (i.e., the sublayer with the multi-head attention encode block 722a and the sub-layer with the feed forward add & norm block 726) found in the encode block 710a, the decode block 714a can include a third sub-layer, which performs multi-head attention over the output of the encoder stack. Similar to the encoder 708, the decoder 712 uses residual connections around each of the sub-layers, followed by layer normalization. Additionally, the sub-layer with the multi-head attention encode block 722a can be modified in the decoder stack to prevent positions from attending to subsequent positions. This masking, combined with fact that the output embeddings are offset by one position, ensures that the predictions for position i can depend only on the known output data at positions less than i.

The linear block 716 can be a learned linear transformation. For example, when the transformer architecture 700 is being used to translate from a first language into a second language, the linear block 716 projects the output from the last decode block 714c into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

The softmax block 718 then turns the scores from the linear block 716 into output probabilities 720 (which add up to 1.0). In each position, the index provides for the word with the highest probability, and then map that index to the corresponding word in the vocabulary. Those words then form the output sequence of the transformer architecture 700. The softmax operation is applied to the output from the linear block 716 to convert the raw numbers into the output probabilities 720 (e.g., token probabilities).

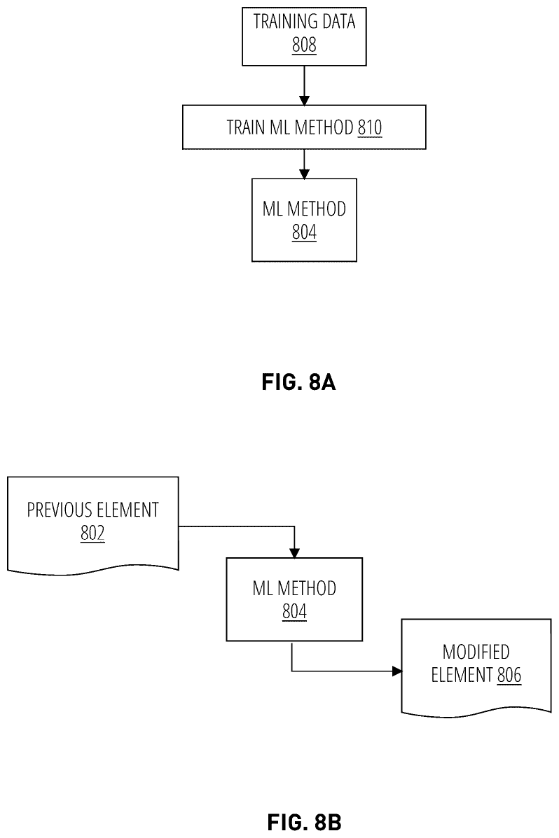

FIG. 8A illustrates an example of training an ML model 804. In step 810, training data previous element 802 is applied to train the ML model 804. For example, the ML model 804 can be an artificial neural network (ANN) that is trained via unsupervised or self-supervised learning using a backpropagation technique to train the weighting parameters between nodes within respective layers of the ANN.

An advantage of the GAN architecture 600 and the transformer architecture 700 is that they can be trained through self-supervised learning or unsupervised methods. The Bidirectional Encoder Representations from Transformer (BERT), For example, does much of its training by taking large corpora of unlabeled text, masking parts of it, and trying to predict the missing parts. It then tunes its parameters based on how much its predictions were close to or far from the actual data. By continuously going through this process, the transformer architecture 700 captures the statistical relations between different words in different contexts. After this pretraining phase, the transformer architecture 700 can be finetuned for a downstream task such as question answering, text summarization, or sentiment analysis by training it on a small number of labeled examples.

In unsupervised learning, the training data 808 is applied as an input to the ML model 804, and an error/loss function is generated by comparing the predictions of the next word in a text from the ML model 804 with the actual word in the text. The coefficients of the ML model 804 can be iteratively updated to reduce an error/loss function. The value of the error/loss function decreases as outputs from the ML model 804 increasingly approximate the training data 808.

For example, in certain implementations, the cost function can use the mean-squared error to minimize the average squared error. In the case of a multilayer perceptrons (MLP) neural network, the backpropagation algorithm can be used for training the network by minimizing the mean-squared-error-based cost function using a gradient descent method.

Training a neural network model essentially means selecting one model from the set of allowed models (or, in a Bayesian framework, determining a distribution over the set of allowed models) that minimizes the cost criterion (i.e., the error value calculated using the error/loss function). Generally, the ANN can be trained using any of numerous algorithms for training neural network models (e.g., by applying optimization theory and statistical estimation).

For example, the optimization method used in training artificial neural networks can use some form of gradient descent, using backpropagation to compute the actual gradients. This is done by taking the derivative of the cost function with respect to the network parameters and then changing those parameters in a gradient-related direction. The backpropagation training algorithm can be: a steepest descent method (e.g., with variable learning rate, with variable learning rate and momentum, and resilient backpropagation), a quasi-Newton method (e.g., Broyden-Fletcher-Goldfarb-Shannon, one step secant, and Levenberg-Marquardt), or a conjugate gradient method (e.g., Fletcher-Reeves update, Polak-Ribiére update, Powell-Beale restart, and scaled conjugate gradient). Additionally, evolutionary methods, such as gene expression programming, simulated annealing, expectation-maximization, non-parametric methods and particle swarm optimization, can also be used for training the ML model 804.

The training (step 810) of the ML model 804 can also include various techniques to prevent overfitting to the training data 808 and for validating the trained ML model 804. For example, bootstrapping and random sampling of the training data 808 can be used during training.

In addition to supervised learning used to initially train the ML model 804, the ML model 804 can be continuously trained while being used by using reinforcement learning.

Further, other machine learning (ML) algorithms can be used for the ML model 804, and the ML model 804 is not limited to being an ANN. For example, there are many machine-learning models, and the ML model 804 can be based on machine learning systems that include generative adversarial networks (GANs) that are trained, For example, using pairs of network measurements and their corresponding optimized configurations.

As understood by those of skill in the art, machine-learning based classification techniques can vary depending on the desired implementation. For example, machine-learning classification schemes can utilize one or more of the following, alone or in combination: hidden Markov models, recurrent neural networks (RNNs), convolutional neural networks (CNNs); Deep Learning networks, Bayesian symbolic methods, general adversarial networks (GANs), support vector machines, image registration methods, and/or applicable rule-based systems. Where regression algorithms are used, they can include but are not limited to: a Stochastic Gradient Descent Regressors, and/or Passive Aggressive Regressors, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

FIG. 8B illustrates an example of using the trained ML model 804. The previous element 802 and/or instructions for modifying the previous element 802 are applied as inputs to the trained ML model 804 to generate the outputs, which can include the modified element 806.

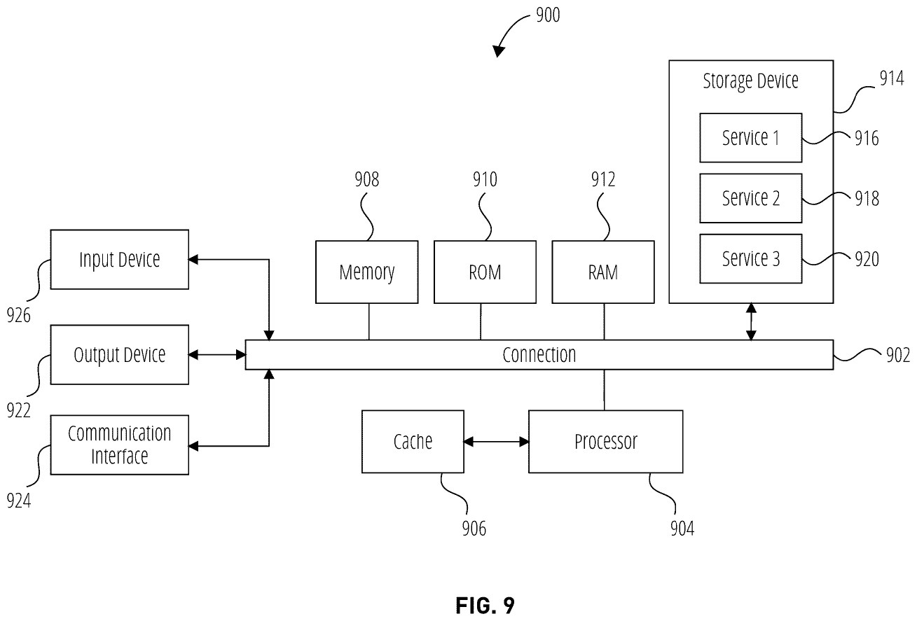

FIG. 9 shows an example of computing system 900. The computing system 900 can be the computing system 300 or the mobile device 316. The computing system 900 can perform the functions of one or more of the units in the system 400 and can be used to perform one or more of the steps of method 500. The computing system 900 can be part of a distributed computing network in which several computers perform respective steps in method 500 and/or the functions of units in system 400. The computing system 900 can be connected to the other parts of the distributed computing network via the connection 902 or the communication interface 924. Connection 902 can be a physical connection via a bus, or a direct connection into processor 904, such as in a chipset architecture. Connection 902 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 900 includes at least one processing unit (CPU or processor) 904 and connection 902 that couples various system components including system memory 908, such as read-only memory (ROM) 808 and random access memory (RAM) 810 to processor 904. Computing system 900 can include a cache of high-speed memory 906 connected directly with, in close proximity to, or integrated as part of processor 904. Processor 904 may essentially be a completely self-contained computing system, containing multiple cores or processors, a bus, memory controller, cache, etc. A multi-core processor may be symmetric or asymmetric.

Processor 904 can include any general-purpose processor and a hardware service or software service, such as services 916, 918, and 920 stored in storage device 914, configured to control processor 904 as well as a special-purpose processor where software instructions are incorporated into the actual processor design. Service 1 916 can identify the extent of a flow between the respective panels, for example. Service 2 918 can include segmenting the each of the panels into segmented elements (e.g., background, foreground, characters, objects, text bubbles, text blocks, etc.) and identifying the content of the each of the segmented elements.

To enable user interaction, computing system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computing system 900. Computing system 900 can include a communication interface 924, which can generally govern and manage the user input and system output. There is no restriction on operating on any particular hardware arrangement, and therefore the basic features here may easily be substituted for improved hardware or firmware arrangements as they are developed.

Storage device 914 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 914 can include software services, servers, services, etc., that when the code that defines such software is executed by the processor 904, it causes the system to perform a function. In some embodiments, a hardware service that performs a particular function can include the software component stored in a computer-readable medium in connection with the necessary hardware components, such as processor 904, connection 902, output device 922, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a system 400 and perform one or more functions of the method 500 when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, For example, instructions and data which cause or otherwise configure a general purpose computer, special purpose computer, or special purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method of modifying a graphic narrative, comprising:
determining edges of panels within respective sheets of the graphic narrative;
segmenting elements within the panels;
applying the segmented elements to a first machine learning (ML) model to predict a narrative flow, the predicted narrative flow comprising an order in which the panels are to be viewed; and
assigning, in accordance with the predicted narrative flow, index values to the respective panels, the index values representing positions in an ordered list that corresponds to the predicted narrative flow.

2. The method of claim 1, wherein
segmenting the elements within the panels further comprising applying a second ML model to identify objects depicted in image elements of the segmented elements and applying a third ML model to identify text elements of the segmented elements; and
applying the segmented elements to the first ML model to predict the narrative flow further comprises
analyzing relations among the text elements a same page to determine first scores representing likelihoods for an order in which the text elements are viewed,
analyzing relations among the text elements a same page to determine second scores representing likelihoods for an order in which the image elements are viewed, and
combining the first scores and the second scores to predict the order in which the panels are to be viewed.

3. The method of claim 1, wherein applying the segmented elements to the first ML model to predict the narrative flow further comprises predicting a flow of action within one or more of the panels.

4. The method of claim 3, wherein the one or more of the panels have larger area than an average area of the panels, and the method further comprises displaying the graphic narrative in a digital format by showing multiple views for each panel of the one or more of the panels, such that a first view of the multiple views for a panel shows a part of the panel corresponding to a first occurrence in the flow of the action and a second view of the multiple views shows a part of the panel corresponding to a second occurrence, wherein the first occurrence proceeds the second occurrence in the flow of the action.

5. The method of claim 4, wherein the displaying the graphic narrative in the digital format further comprises transitioning from the first view of the panel to the second view of the panel by zooming, panning, changing a focus, highlighting, or fading from the first view of the panel to the second view of the panel.

6. The method of claim 1, further comprising:
determining scores representing uncertainties for the index values of the respective panels within the ordered list;
flagging panels for which the scores of the flagged panels exceed a predefined threshold;
sending, to a user device, the panels associated with the corresponding index values and indicia of which of the panels have been flagged; and
modifying the predicted narrative flow based on user interface inputs indicating corrections to the predicted narrative flow.

7. The method of claim 1, further comprising:
ingesting the graphic narrative;
slicing the graphic narrative into respective pages and determining an order of the pages;
determining that panels on a page earlier in the order of the pages occur earlier in the predicted narrative flow than panels on a page that is later in the order of the pages; and
displaying, on a display of a device, the panels according to the predicted order in which the panels are to be viewed.

8. The method of claim 1, further comprising:
displaying, on a display of a device, the panels according to the predicted order in which the panels are to be viewed, and rendering the panels in accordance with a screen size of the display of the device, wherein
the device is an electronic reading device, a tablet or a smartphone on which is running electronic reading application; a website accessed via a web browser; or printing a copy of an electronic version of the graphic narrative.

9. The method of claim 1, further comprising:
modifying the panels to increase a uniformity of a size and/or shape of the panels, such that the modified panels are compatible with being displayed as an electronic version of the graphic narrative.

10. The method of claim 1, further comprising:
displaying, on a display of a device, the panels with a visual indicator directing a reader according to the predicted narrative flow.

11. The method of claim 1, further comprising:
receiving reader inputs that control an advancement of the graphic narrative along the predicted narrative flow.

12. The method of claim 1, wherein segmenting elements within the panels further comprises:
applying a second ML model to a panel of the panels, the first ML model determining bounded regions within the panel that correspond to background, foreground, text bubbles, objects, and/or characters, and identifying the bounded regions as the segmented elements.

13. The method of claim 12, wherein segmenting the elements within the panels is performed using a semantic segmentation method that is selected from the group consisting of a Fully Convolutional Network (FCN) method, a U-Net method, a SegNet method, a Pyramid Scene Parsing Network (PSPNet) method, a DeepLab method, a Mask R-CNN, an Object Detection and Segmentation method, a fast R-CNN method, a faster R-CNN method, a You Only Look Once (YOLO) method, a fast R-CNN method, a PASCAL VOC method, a COCO method, a ILSVRC method, a Single Shot Detection (SSD) method, a Single Shot MultiBox Detector method, and a Vision Transformer (ViT) method.

14. The method of claim 2, wherein applying the segmented elements to the first ML model further comprises:
applying, to the respective image elements, an image classifier to identify types of objects illustrated within the respective image elements; and
applying, to respective of the text elements, a character recognition method to determine text of the respective text element and applying the text to a language model to determine one or more referents of the text.

15. The method of claim 14, wherein
the image classifier is selected from the group consisting of a K-means method, an Iterative Self-Organizing Data Analysis Technique (ISODATA) method, a YOLO method. A ResNet method, a ViT method, a Contrastive Language-Image Pre-Training (CLIP) method, a convolutional neural network (CNN) method, a MobileNet method, and an EfficientNet method; and
the language model is selected from the group consisting of a transformer method, a generative pre-trained transformers (GPT), a Bidirectional Encoder Representations from Transformers (BERT) method, and a T5 method.

16. A computing apparatus comprising:
a processor; and
a memory storing instructions that, when executed by the processor, configure the apparatus to:
determine edges of panels within respective sheets of a graphic narrative;
segment elements within the panels;
apply the segmented elements to a first machine learning (ML) model to predict a narrative flow, the predicted narrative flow comprising an order in which the panels are to be viewed; and
assign, in accordance with the predicted narrative flow, index values to the respective panels, the index values representing positions in an ordered list that corresponds to the predicted narrative flow.

17. The computing apparatus of claim 16, wherein, when executed by the processor, the instructions stored in the memory further configure the apparatus to:
segment the elements within the panels by applying a second ML model to identify objects depicted in image elements of the segmented elements and applying a third ML model to identify text elements of the segmented elements; and
apply the segmented elements to the first ML model to predict the narrative flow by
analyzing relations among the text elements a same page to determine first scores representing likelihoods for an order in which the text elements are viewed,
analyzing relations among the text elements a same page to determine second scores representing likelihoods for an order in which the image elements are viewed, and
combining the first scores and the second scored to predict order in which the panels are to be viewed.

18. The computing apparatus of claim 16, wherein, when executed by the processor, the instructions stored in the memory further configure the apparatus to:
determine scores representing uncertainties for the index values of the respective panels within the ordered list;
flag panels for which the scores of the flagged panels exceed a predefined threshold;
send, to a user device, the panels associated with the corresponding index values and indicia of which of the panels have been flagged; and
modify the predicted narrative flow based on user interface inputs indicating corrections to the predicted narrative flow.

19. The computing apparatus of claim 16, wherein, when executed by the processor, the instructions stored in the memory further configure the apparatus to:
ingest the graphic narrative;
slice the graphic narrative into respective pages and determine an order of the pages;
determine that panels on a page earlier in the order of the pages occur earlier in the predicted narrative flow than panels on a page that is later in the order of the pages; and
display, on a display of a device, the panels according to the predicted order in which the panels are to be viewed.

20. The computing apparatus of claim 16, wherein, when executed by the processor, the instructions stored in the memory further configure the apparatus to:
display, on a display of a device, the panels according to the predicted order in which the panels are to be viewed, and rendering the panels in accordance with a screen size of the display of the device, wherein
the device is an electronic reading device, a tablet or a smartphone on which is running an electronic reading application; or a website accessed via a web browser.
